(19) United States
(12) Patent Application Publication
(10) Pub. No.: US 2019/0221208 A1
(43) Pub. Date: Jul. 18, 2019

(54) METHOD, USER INTERFACE, AND DEVICE FOR AUDIO-BASED EMOJI INPUT

(71) Applicant: KIKA TECH (CAYMAN) HOLDINGS CO., LIMITED, Beijing (CN)

(72) Inventors: Hao CHEN, Beijing (CN); Conglei YAO, Beijing (CN); Yu LIU, Beijing (CN)

(21) Appl. No.: 15/870,399

(22) Filed: Jan. 12, 2018

(51) Int. Cl. G10L 15/22; G10L 15/18; G06F 3/0481; G06F 3/0482; G06F 3/16

(52) U.S. Cl. CPC G10L 15/22; G10L 15/1815; G10L 2015/223; G06F 3/0482; G06F 3/167; G06F 3/04817

(57) ABSTRACT

A method, a user interface, and a device for audio-based emoji input are provided. The method includes: converting an audio signal input by a user into text through an automatic speech recognition (ASR) module; through natural language understanding and based on the text, recognizing one or more emojis satisfying an input intention of the user; requesting a confirmation of input of a recognized emoji or selection of an emoji from a plurality of recognized emojis; receiving a user response; and based on the user response, executing a corresponding operation.

### FIELD OF THE DISCLOSURE

The present disclosure generally relates to the field of information input technology and, more particularly, relates to a method, a user interface, and a device for audio-based emoji input.

### BACKGROUND

Emojis are a type of characters usually applied to express human emotions and have become popular across the world after being encoded in the Unicode standard. Every day a huge number of emojis are selected and sent by users through messages. Moreover, emojis are not only used in social networking, but are also adopted in the field of formal writing, such as government reports and research papers.

Emojis also change the way we use network languages. When we use emojis and emoticons during a chat, our brains recognize such emojis and emoticons by processing them as non-language information, indicating that we humans interpret emojis and emoticons as emotional expression. This is similar to the way we interpret facial expressions, voice tone, gesture, and body posture, but not the way we read words and listen to voice. In other words, the function of the emojis in the word information is similar to the function of the tone when we make phone calls or the function of the gestures when we perform face-to-face communication.

Using the keyboard to realize non-verbal communication is a major breakthrough brought about by the emojis. Recently, under scenarios of audio input, the demand for applications of emojis has also increased, but often the user is not able to view the screen of the input device constantly nor use his or her hand to operate on the input device. Thus, it is desirable to develop an approach to use and input emojis through voice interaction.

### BRIEF SUMMARY OF THE DISCLOSURE

One aspect of the present disclosure provides a method for audio-based emoji input according to embodiments of the present disclosure. The method includes: converting an audio signal input by a user into text through an automatic speech recognition (ASR) module; based on the text, recognizing one or more emojis satisfying an input intention of the user; requesting a confirmation of input of a recognized emoji or selection of an emoji from a plurality of recognized emojis; receiving a user response; and based on user response, executing a corresponding operation.

Another aspect of the present disclosure provides a device for audio-based emoji input according to embodiments of the present disclosure. The device includes an audio collecting unit, at least one processor, and an audio broadcasting unit. The audio collecting unit is configured to receive an audio signal sent by a user. The at least one processor is coupled to the audio collecting unit, and the at least one processor is configured to, receive the audio signal sent by the user, perform automatic speech recognition (ASR) on the received audio signal to convert the audio signal into text, and based on the text, recognize one or more emojis satisfying an input intention of the user. The audio broadcasting unit is configured to request the user to confirm input of a recognized emoji or select an emoji from a plurality of recognized emojis. Further, in response to receiving a user response, the at least one processor is configured to execute a corresponding operation.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for the description of the embodiments are briefly introduced below. Obviously, the drawings described hereinafter are only some embodiments of the present disclosure, and it is possible for those ordinarily skilled in the art to derive other drawings from the following drawings without creative effort.

FIG. 1 illustrates an exemplary flow chart showing a method for audio-based emoji input according to embodiments of the present disclosure;

FIG. 2 illustrates an exemplary scenario in which a user interacts with a smart home system including a smart TV and a microphone for receiving audio data from the user;

FIG. 3 illustrates an exemplary scenario in which a smart TV included in a smart home system recommends an emoji to a user after receiving an audio signal from the user;

FIG. 4 illustrates an exemplary scenario in which a user confirms to add an emoji after receiving an audio piece broadcasted by a loudspeaker;

FIG. 5 illustrates another exemplary flow chart showing a method for audio-based emoji input according to embodiments of the present disclosure;

FIG. 6 illustrates another exemplary scenario in which a user interact with a smart home system including a smart TV and a microphone for receiving audio data from the user;

FIG. 7 illustrates an exemplary scenario in which a smart TV included in a smart home system automatically recommends an emoji to a user after receiving an audio signal without mentioning “emoji” from the user;

FIG. 8 illustrates an exemplary scenario in which a user confirms to add an emoji to text converted from an audio signal;

FIG. 9 illustrates an exemplary user interface showing a text converted from an audio signal sent by a user;

FIG. 10 illustrates an exemplary user interface showing an emoji recognized based on natural language understanding of a text converted from an audio signal;

FIG. 11 illustrates an exemplary user interface showing input of an emoji into a message; and

FIG. 12 illustrates an exemplary structural schematic view of a device for audio-based emoji input.

### DETAILED DESCRIPTION

Based on detailed descriptions of embodiments in the present disclosure and with reference to the accompanying drawings, other aspects, advantages, and features of the present disclosure will become obvious to those skilled in the relevant art.

In the present disclosure, the terms “comprise”, “comprising”, or any other variation thereof are intended to cover a non-exclusive inclusion, and the term “or” is inclusive, meaning both or either.

In the specification, various embodiments provided hereinafter for describing principles of the present disclosure are for illustrative purposes only, and shall not be construed as limiting the present disclosure. With reference to the accompanying drawings, the following descriptions are provided to aid thorough understanding of the exemplary embodiments in the present disclosure defined by the appended claims and their equivalents.

The following descriptions may include various specific details to aid the understanding, and such details are for illustrative purposes only. Thus, those ordinarily skilled in the relevant art shall realize that, without departing from the scope and spirit of the present disclosure, various alterations and modifications can be made to embodiments described in this paper. Further, for clarity and concision, descriptions of well-known functions and structures are omitted. Additionally, throughout the accompanying drawings, the same reference numerals are applied for similar functions and operations.

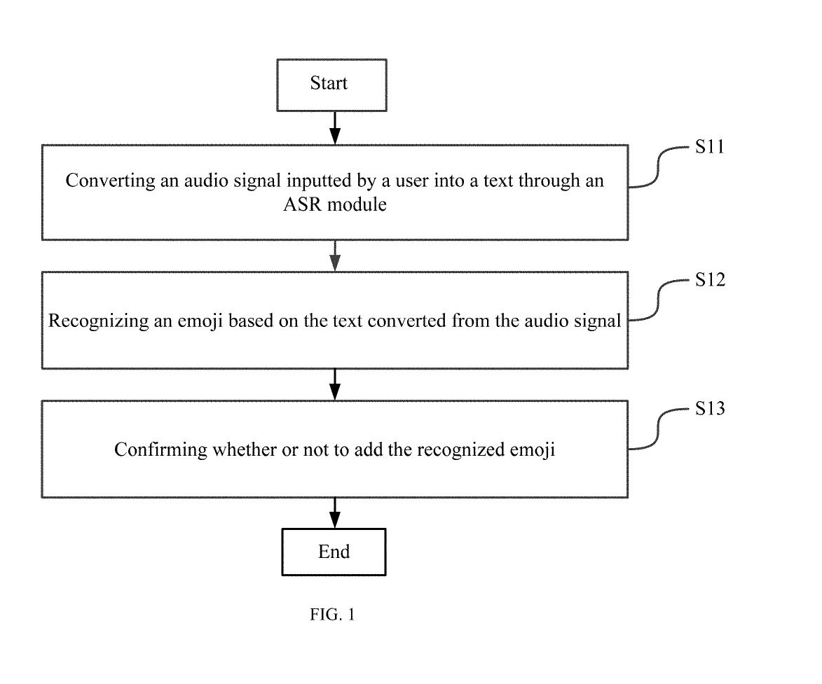

In order to allow a user to input an emoji through audio signal(s) under situations where the user cannot input emoji manually by operating on a touch screen, or a keyboard, etc., the present disclosure provides a method for audio-based emoji input. FIG. 1 illustrates an exemplary flow chart showing a method for audio-based emoji input, which may be applicable to a device, such as a smart phone, tablet, computer, and smart TV, etc. As shown in FIG. 1, the method comprises the followings.

At S11, the device converts an audio signal inputted by a user into text through an automatic speech recognition (ASR) module.

More specifically, the device may be an input device located within a computing system, and the computing system may include a user apparatus or a network apparatus. When the input device is located within the network apparatus, communication between the user and the input device may be carried out through the network. When the input device is located within the user apparatus, the audio signal such as verbal command generated by the user may be received by the input device through one or more microphones. The one or more microphones may or may not be integrated with the user apparatus.

Correspondingly, the ASR module may be realized based on audio service from a cloud or the locally installed speech recognition engine (e.g., application program interface, API). For example, the audio signal received by the microphone may be directed to an API of an input application for future processing. In this example and similar examples hereinafter, the text converted by the input device from the audio signal inputted by the user may be referred as a speech recognition result.

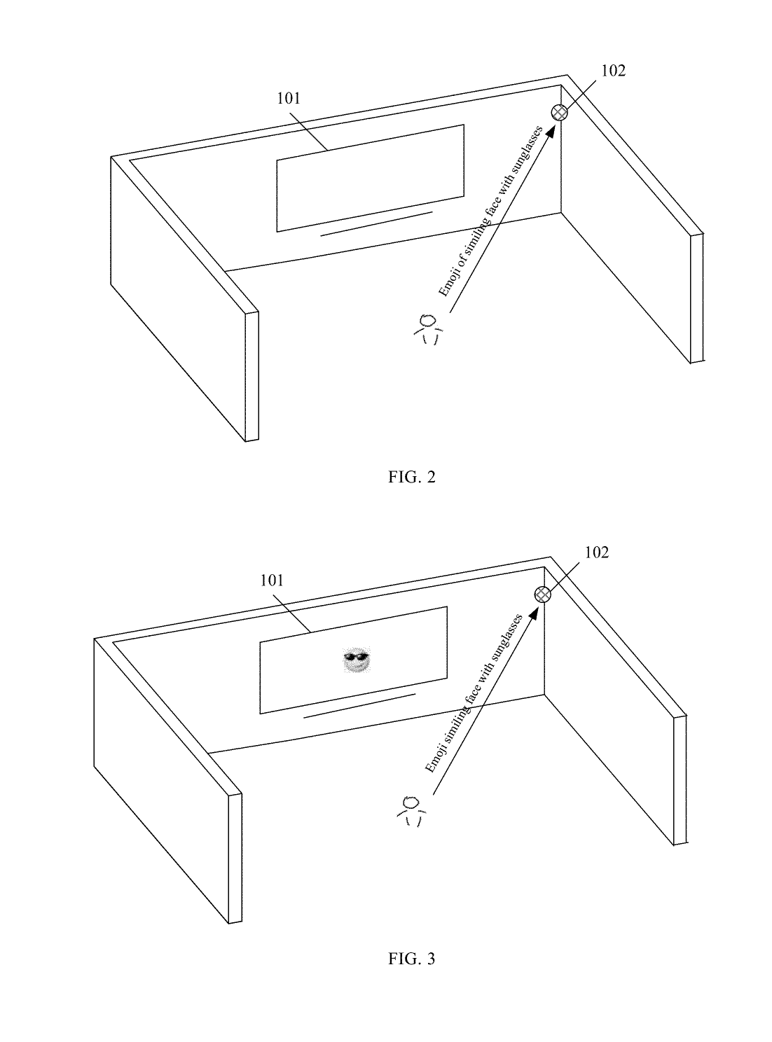

In one example, FIG. 2 illustrates an exemplary scenario in which a user interacts with a smart home system including a smart TV and a microphone. As shown in FIG. 2, to input the emoji “ [symbol] ” that is commonly used in social networking language, the user standing in a room of a building furnished with the smart home system may say “emoji of smiling face with sunglasses”, “emoji smiling face with sunglasses”, or “smiling face with sunglasses emoji” to the smart TV 101. The audio signal such as “Emoji of smiling face with sunglasses” may be then collected by the microphone 102 and transmitted to the smart TV 101 for conversion into the corresponding text.

In some embodiments, to broaden the voice collection range of the smart home system, two or more microphones may be installed at different locations (e.g., different walls, floors or corners of the same or different rooms) of the building furnished with the smart home system. Thus, even if the user is in a room other than the one where the smart TV is placed, the microphone closest to the user may still be able to collect the audio signal from the user and further transmit the audio signal to the smart TV for processing into a text.

At S12, the device recognizes an emoji that a user intends to input based on the text converted from the audio signal.

More specifically, based on the text converted from the audio signal (i.e., the speech recognition result), the device may recognize that the user intends to actively input an emoji. For example, one or more keywords may be extracted by analyzing the speech recognition result, and responsive to the speech recognition result including the keyword “emoji” or “emoticon”, the device recognizes that the intention of the user is to input an emoji. In some embodiments, each emoji has a corresponding description, and a locally stored emoji database or an emoji database accessible from a server is utilized to look up an emoji and its corresponding description.

Based on the aforementioned speech recognition result and the description of each emoji, a set of emojis with descriptions close to the speech recognition result may be identified, for example, by semantic understanding. Further, one or more emojis with the description closest to the speech recognition result may be recognized and recommended to the user.

It should be noted that the relationship between the emoji and description may not be a one-to-one correspondence relationship, but implementation principles and procedure can be relatively easily understood by those skilled in the relevant art. Thus, similar and repeated illustrations are not provided herein. In some embodiments, for example, one emoji may correspond to multiple descriptions, and vice versa.

In some embodiments, semantic similarity may be used as a parameter to identify the set of emojis that have descriptions close to the speech recognition result, and for each emoji, the semantic similarity may be evaluated by a similarly score calculated based on the speech recognition result and the description of the emoji. In one embodiment, given a speech recognition result, the similarity score of an emoji may be calculated using the following equation:

$${d}_{ij} = \frac{{s}_{ij}}{\sqrt{{n}_{i} {n}_{j}}} ,$$

where nᵢ and nⱼ represent the number of words in the short text i (i.e., the speech recognition result) and short text j (i.e., the description of the emoji), respectively, and sᵢⱼ represents the number of the same words in the two short texts. Specifically, given the speech recognition result “emoji smiling face with sunglasses” converted from an audio signal, for the emoji “ [symbol] ” having the description “smiling face with sunglasses”, the similarity score can be calculated to be approximately 0.894 using the aforementioned equation.

Further, pre-processing of the speech recognition result may be performed to remove one or more targeted words such as “emoji” or “emoticon” from the speech recognition result. Accordingly, given the speech recognition result “emoji smiling face with sunglasses” converted from an audio signal, the pre-processed speech recognition result would be “smiling face with sunglasses”, and for each emoji, the similarity score may be calculated based on the pre-processed speech recognition result and the description of the corresponding emoji. That is, for the emoji “ [symbol] ” having the description “smiling face with sunglasses”, the similarity score can be calculated to be 1.0 (the highest possible score, indicating a perfect match in this example) using the aforementioned equation.

In another embodiment, the similarity score may be calculated based on the cosine similarity between the speech recognition result and the description of an emoji, where the speech recognition result and the description of the emoji are both short texts represented by a vector Vi and a vector Vj, respectively. The cosine similarity may be calculated using the equation

$$cos ( θ ) = \frac{{V}_{i} \cdot {V}_{j}}{‖ {V}_{i} ‖ ‖ {V}_{j} ‖} ,$$

and there may be various approaches available to obtain the vectors Vi and Vj that correspond to the speech recognition result and the description of the emoji, respectively. In different approaches, the vectors Vi and Vj may have different numerical representations.

In one approach, frequency-based word embedding may be applied as a technique to map each keyword in the speech recognition result or the description of the emoji into a number using a dictionary, thereby obtaining the vectors Vi and Vj that correspond to the speech recognition result and the description of the emoji, respectively. The dictionary herein may be a list of words containing all keywords shown in the speech recognition result and the description of the emoji. It should be noted that not all words in the speech recognition result or the description of the emoji are keywords, for example, words such as “of” and “with” may not be counted as keywords. Based on the dictionary, each keyword in the speech recognition result may be mapped into a number that represents a corresponding keyword frequency in the speech recognition result. Similarly, each keyword in the description of an emoji may be mapped into a number that represents a corresponding keyword frequency in the description of the emoji. The keyword frequency herein may refer to the number of times that a keyword occurs in a text like the speech recognition result or description of the emoji.

For example, under a scenario where the pre-processed speech recognition result is “smiling face with sunglasses” and the description of an emoji [symbol] is “smiling face with glasses”, the dictionary may be determined to be the following list of keywords: {smiling, face, sunglasses, glasses}. Based on such dictionary and the keyword frequency, the Vi representing the speech recognition result is determined as (1, 1, 1, 0), and the Vj representing the description of the emoji [symbol] is determined as (1, 1, 0, 1). Thus, the cosine similarity between the speech recognition result and the description of the emoji [symbol] is calculated to be approximately 0.667.

In other embodiments, the similarity score may be calculated based a distance between the speech recognition result and the description of an emoji. The prediction-based word embedding (e.g., word2vec embedding) may be applied as an algorithm based on neural network to map each keyword in the speech recognition result or the description of the emoji into a word vector. Further, the similarity score may be calculated based on the distance between the speech recognition result and the description of an emoji using the acquired word vectors. There are also other ways to calculate the similarity score, and the present disclosure is not limited thereto.

Further, if the similarity score of an emoji exceeds a preset threshold, the emoji may be recommended to the user. The preset threshold may be adjusted, for example, based on the requirement on the precision of emoji input. For example, if the requirement on the precision of emoji input becomes higher, the preset threshold may need to be increased.

Further, if there are a plurality of emojis having a similarity score exceeding the preset threshold, respectively, the plurality of emojis may be recommended to the user based on a descending order of the similarity scores, or the emoji with the highest similarity score may be recommended to the user.

In one example, FIG. 3 illustrates an exemplary scenario in which a smart TV included in a smart home system recognizes and recommends an emoji to a user after receiving an audio signal from the user. As shown in FIG. 3, the user may say “Emoji smiling face with sunglasses” to the smart TV 101, and an external microphone 102 may collect and transmit the audio signal “Emoji smiling face with sunglasses” to the smart TV 101 for conversion into the text. The smart TV 101 may recognize the input intention of the user (i.e., the emoji that the user intends to input) through semantic understanding of the aforementioned text, and determine “ [symbol] ” to be the emoji most matched with the input intention of the user. In some embodiments, the smart TV 101 may further recommend the emoji “ [symbol] ” to the user by displaying it on the screen.

At S13, the user confirms whether or not to add the recognized emoji or selects from a plurality of recognized emojis for input.

More specifically, after the device obtains emoji(s) recognized at S12, an audio piece may be generated and broadcasted to ask the user whether or not to add an emoji or which one to select from a plurality of emojis. For example, if the device recognizes and/or recommends one emoji at S12, the audio piece “Please confirm, add or not” may be delivered to the user. If the device recognizes and/or recommends a plurality of emojis at S12, the audio piece “Please select one” may be delivered to the user.

In some embodiments, the audio piece generated by the device may be delivered to the user through an audio broadcasting unit, and the audio broadcasting unit may or may not be integrated with the device. The audio broadcasting unit may be a loudspeaker or may include one or more loudspeakers, and the number and location(s) of the loudspeakers included in the audio broadcasting unit are not specifically limited.

Further, in response to the audio piece delivered through the audio broadcasting unit, the user may send an answering command to the device, so as to instruct the device whether or not to add the emoji or which specific emoji to add. The device may again converts the audio signal (i.e., the answering command) from the user into text (i.e., speech recognition result) through the ASR module, and perform semantic recognition of the speech recognition result to understand the intention of the user. Further, the device may execute a corresponding operation to add the emoji, to select and add an emoji from a plurality of emojis, or to end the current audio input process.

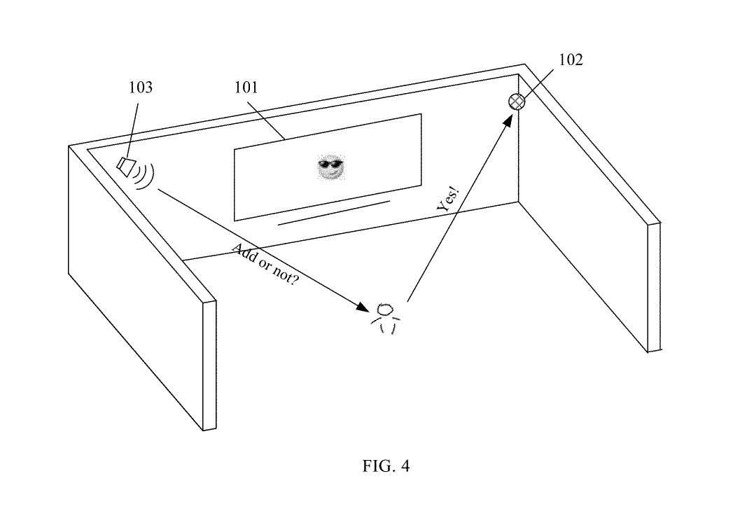

In one example, FIG. 4 illustrates an exemplary scenario in which a user confirms to add an emoji after receiving an audio piece broadcasted by a loudspeaker that asks whether or not to add the emoji. As shown in FIG. 4, after recognizing the emoji “ [symbol] ” based on the text converted from an audio signal from the user, the smart home system including a smart TV may recommend the emoji “ [symbol] ” to the user by delivering an audio piece such as “Add or not” through a loudspeaker 103, or by displaying the emoji “ [symbol] ” with or without an instruction on the screen of the smart TV 101, or by a combination thereof.

In response, the user may send out an answering command “Yes!” to the smart TV 101, and the microphone 102 may collect the answering command “Yes!” to the smart TV 101 and transmit such command to the smart TV for conversion into text. The smart TV 101 may further perform semantic recognition on the text to understand the user intention, and execute an operation based on the user intention. That is, based on the text “yes” converted from the audio signal “Yes!”, the smart TV 101 may add the emoji “ [symbol] ” to a message that the user is going to send to others, or to a sentence or passage in a file that the user creates, or for other purposes.

Through the above-described method embodiments, the user may conveniently input emoji through audio signal(s), and based on the emotional property of the emoji, the non-face-to-face communication of the user may be improved. Such solution is particularly suitable for scenarios under which a touch screen is unavailable or the user cannot manually operate the device such as smart TV, smart home, or smart GPS.

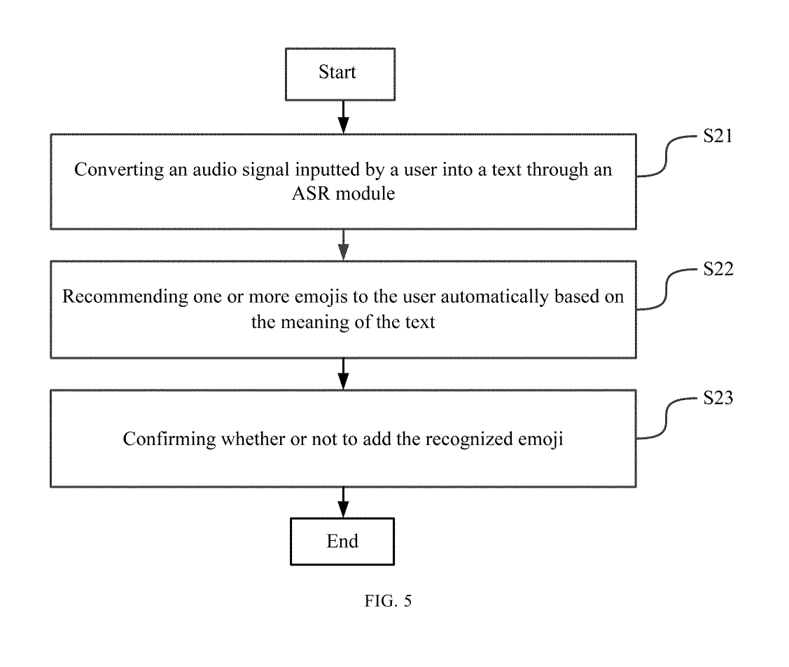

FIG. 5 illustrates another exemplary flow chart showing a method for audio-based emoji input, which may be applicable to a device, such as a smart phone, tablet, computer, and PDA, etc. As shown in FIG. 5, the method comprises the followings.

At S21, the device converts an audio signal inputted by a user into text through an automatic speech recognition (ASR) module. The obtained text herein may be referred to as a speech recognition result, and the ASR module may be realized based on audio service from cloud or the locally installed speech recognition engine (e.g., application program interface, API).

In some embodiments, the audio signal inputted by the user may be collected by an audio collecting unit (e.g., a microphone) and may further be transmitted by the audio collecting unit to the device to be converted into text.

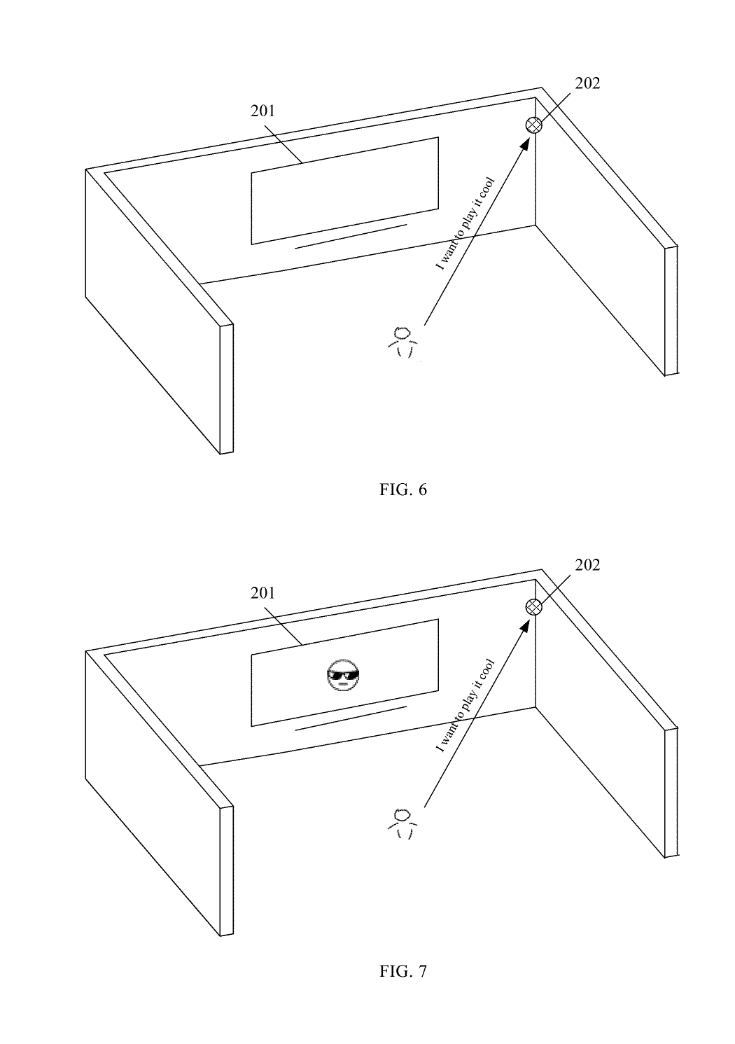

In one example, FIG. 6 illustrates another exemplary scenario in which a user interact with a smart home system including a smart TV and a microphone. As shown in FIG. 6, a user standing in a room of a building furnished with a smart home system may say “I want to play it cool” to the smart TV 101. The microphone 102 may collect and transmit the audio signal “I want to play it cool” to the smart TV 101 for conversion into text through the ASR module.

At S22, the device automatically recommends one or more emojis to the user based on the meaning of the text converted from the audio signal.

More specifically, through semantic understanding, the device may recognize that the user wants the device to recommend one or more emojis for input purposes. For example, instead of providing an audio signal mentioning “emoji”, the user may send out an audio signal without mentioning “emoji” to the device, and the device may obtain a corresponding text through a voice-to-text conversion function of the ASR module that does not include the word “emoji”. Thus, the device may automatically recommends one or more emojis to the user based on the meaning of the text.

For example, based on a machine learning algorithm, the device may predict a plurality of emojis that the user may want to input succeeding the text converted from the audio signal of the user (i.e., the speech recognition result). The device may calculate a prediction score for each of the plurality of predicted emojis, and recommend one or more emojis having a prediction score that exceeds a pre-determined threshold to the user. The pre-determined threshold may be adjusted, for example, based on the requirement on the precision of emoji input. That is, if the requirement on the precision of emoji input becomes higher, the preset threshold may need to be increased.

In implementation, the Bidirectional Long Short-Term Memory Recurrent Neural Networks (BLSTM-RNN) model may be applied to predict whether the emoji intends to input an emoji and may be further utilized to recommend one or more emojis to the user.

In one example, FIG. 7 illustrates an exemplary scenario in which a smart TV included in a smart home system automatically recommends an emoji to a user after receiving an audio signal without mentioning “emoji” from the user. As shown in FIG. 7, the user may say “I want to play it cool” to the smart TV 201, and an external microphone 202 may collect and transmit the audio signal “I want to play it cool” to the smart TV 201 for conversion into text. Based on a machine learning algorithm and the text, the smart TV 201 may predict an emoji that the user might want to input following the text or predict a plurality of emojis for the user to choose the emoji that he or she most want to input. In some embodiments, the smart TV 201 may recommend one or a plurality of emojis (e.g., the emoji “ [symbol] ”) for display on the screen of the smart TV 201.

In some embodiments, a prediction score may be calculated based on the descriptions related to each emoji of an emoji database and the text converted from the audio signal. For example, each description of an emoji can be treated as a training sentence including one or more words. The training sentences of the emojis may be clustered to obtain a plurality of interpretive categories, and based on the correspondence relationship between the training sentences and the emojis, emojis included in each interpretive categories may be determined. Based on the training sentences and words in each interpretive category, a target interpretive category having the highest possibility that the speech recognition result belongs to may be determined, for example, using the Bayes theorem. Further, one or more emojis in the target interpretive category having a prediction score that exceeds a pre-determined threshold may be recommended to the user for further input.

In some embodiments, the device may collect a user's texting and other communication history on the device and/or articles over the internet, and build a language database of language patterns. The device then may calculate a prediction score based on the descriptions related to each emoji and text converted from an audio signal, as well as the user's past language patterns. In some embodiments, the device may further collect and perform big data analysis on a user's and his or her friends' texting and other communication history on the device, and build a language database of language patterns. The device then may calculate a prediction score based on the descriptions related to each emoji and text converted from an audio signal, as well as the language patterns.

At S23, the user confirms whether or not to add the recommended emoji or selects from a plurality of recommended emojis for input.

More specifically, after the device obtains emoji(s) recommended at S22, an audio piece may be generated and broadcasted through a broadcasting unit to ask the user whether or not to add an emoji or which one to select from a plurality of emojis. If the device recommends one emoji at S22, an audio piece such as “please confirm, add or not” may be delivered to the user, and if the device recommends a plurality of emojis at S22, an audio piece such as “please select one” may be delivered to the user. Further, the broadcasting unit may include a loudspeaker or a group of loudspeakers, and the present disclosure is not limited thereto.

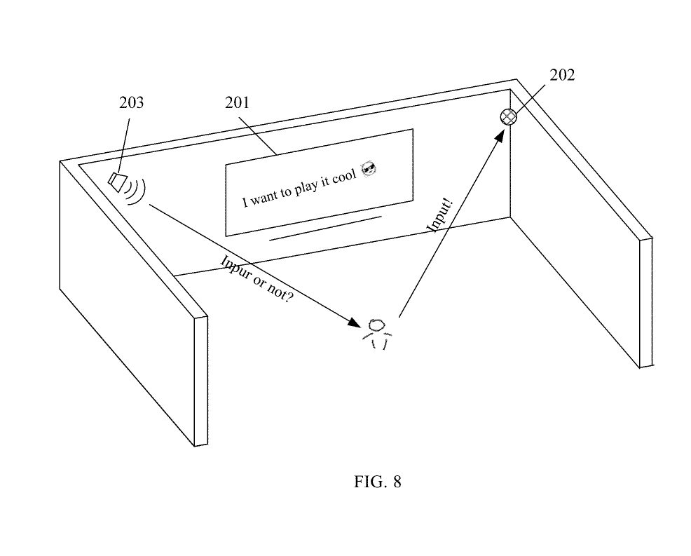

In one example, FIG. 8 illustrates an exemplary scenario in which a user confirms to add an emoji to text converted from an audio signal. As shown in FIG. 8, based on the audio signal “I want to play it cool” and the machine learning algorithm, a smart TV 201 may recommend the emoji “ [symbol] ” to the user by synthesizing and sending an audio piece, such as “Input or not”, to the user. The user may respond by sending an audio signal such as “Yes!” or “Input!” to a microphone 202 that is coupled to the smart TV 201. After receiving the audio signal (e.g., Input!), the smart TV 201 may convert it into text and perform semantic recognition on the text. Based on the semantic recognition result, the smart TV 201 may execute an operation to display the emoji “ [symbol] ” together with the text corresponding to the original audio signal “I want to play it cool” on the screen of the smart TV 201.

The present disclosure further provides a user interface for audio-based emoji input. The user interface may be displayed on a display screen of an electronic device such as a smart phone, a smart TV, or a tablet.

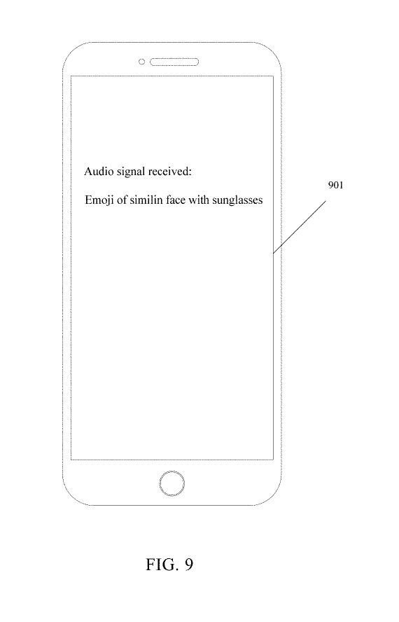

In response to receiving an audio signal from a user, the electronic device may convert the audio signal into text through an ASR module. The audio signal may be, for example, received by the electronic device through an embedded microphone. In one example, FIG. 9 illustrates an exemplary user interface showing a text converted from an audio signal sent by a user. As shown in FIG. 9, after receiving an audio signal “emoji of smiling face with sunglasses”, the electronic device may convert the audio signal into text and display the text on the user interface 901, alone or with other explanation sentence(s). The text may be configured by the user to stay on the user interface 900 for a preset period of time to notify the user that the audio signal is received or converted. In some embodiments, the text may not be shown, and the user interface 901 may display a message such as “audio signal converted” upon converting the audio signal into text.

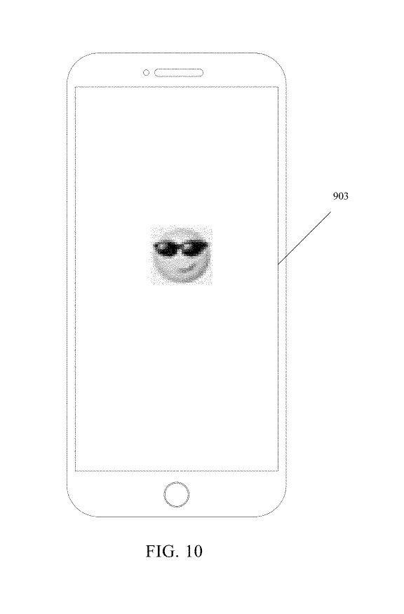

Further, through natural language understanding (NLU), the electronic device may recognize an emoji that the user intends to input or automatically recommend an emoji to the user for input. In one embodiment, through NLU and based on a text mentioning the word “emoji” or “emoticon”, the electronic device may recognize an emoji that the user intends to input. For example, FIG. 10 illustrates an exemplary user interface showing an emoji recognized based on natural language understanding of a text converted from an audio signal.

As shown in FIG. 10, after the text converted from the audio signal “emoji of smiling face with sunglasses” undergoes natural language understanding, the electronic device may recognize and display an emoji “ [symbol] ” on a user interface 903. Further, an audio piece such as “Please confirm whether or not input” may be sent to the user through an embedded speaker or other sound broadcasting unit at approximately the same when the emoji is displayed on the user interface 903 or shortly after the emoji is displayed.

In some embodiments, before the text converted from the audio signal sent by the user undergoes NLU, the electronic device may display another user interface showing a question such as “Continue?” or send out an audio piece asking the user whether or not to continue processing the text. After obtaining confirmation from the user, the electronic device may then display the user interface 903 displaying the recognized emoji based on the text converted from the audio signal.

In some embodiments, two or more corresponding emojis may be displayed on the user interface 903, and the electronic device may ask the user to select one emoji for input. Each emoji may has a corresponding description or several descriptions, and the displaying order of the two or more corresponding emojis may be determined based on a similarity score calculated using a mapping relationship between emojis and corresponding descriptions, and the text converted from the audio signal. The mapping relationship between emojis and corresponding descriptions may be stored locally in the electronic device or may be accessed from a server. Further, the mapping relationship between emojis and corresponding descriptions may be updated periodically or manually based on demand. For example, description(s) of an emoji may be updated by adding, modifying and/or deleting one or more keywords, such that the mapping relationship is updated correspondingly.

In another embodiment, through natural language understanding (NLU), the electronic device notices the user does not directly ask to input an emoji. Under such situation, the electronic device may predict a plurality of emojis for input by the user based on the understanding result of the text converted from the audio signal. For one or more emojis showing a prediction score higher than a pre-determined threshold, the electronic device may recommend and display the one or more emojis on a user interface of the electronic device. Similarly, an audio piece such as “please confirm whether or not input” or “please choose one for input” may be sent to the user through an embedded speaker at approximately the same when the emoji is displayed on the user interface or shortly after the emoji is displayed.

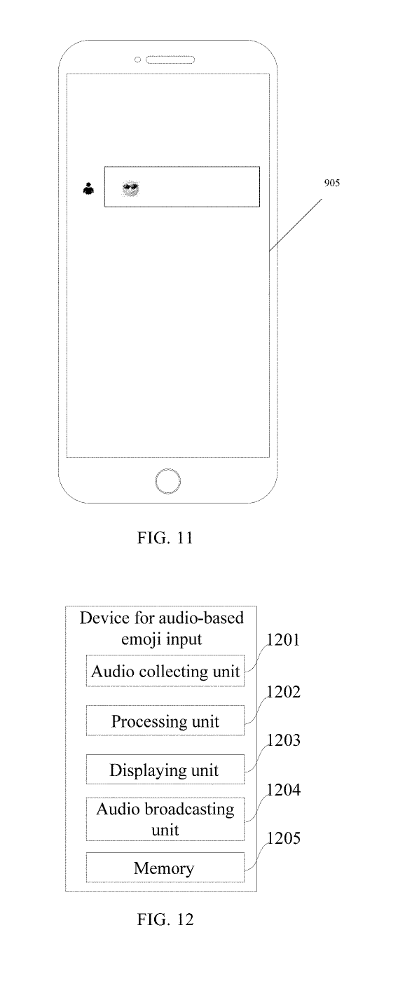

Further, after receiving confirmation from the user that allows input of an emoji displayed on the user interface, the electronic device may input the emoji on a user interface showing the file or message where the emoji needs to be input. FIG. 11 illustrates an exemplary user interface showing input of an emoji into a message. As shown in FIG. 11, after the user confirms to input the emoji “ [symbol] ” on a user interface 905, the emoji “ [symbol] ” may be input into a message that the user plans to send out.

The present disclosure further provides a device for audio-based emoji input. The device may be a smartphone, a smart TV, or other input devices. The input device may be included in a user apparatus or a network apparatus, and the present disclosure is not limited thereto. FIG. 12 illustrates an exemplary structural schematic view of a device for audio-based emoji input. As shown in FIG. 12, the device may include an audio collecting unit 1201, a processing unit 1203, a displaying unit 1205, an audio broadcasting unit 1207, and a memory 1209.

The audio collecting unit 1201 may be configured to receive an audio signal sent by the user and transmit the audio signal to the processing unit 1203 for processing. The audio collecting unit 1201 may be a microphone or an array of microphones disposed based on actual demand.

The processing unit 1203 may include one or more processors for processing data and computer-readable instructions. For example, the processing unit 1203 may be configured to perform automatic speech recognition (ASR) on the audio signal transmitted from the audio collecting unit 1201, thereby converting the audio signal into text for display by the displaying unit 1205. Further, the processing unit 1203 may be configured to perform natural language understanding (NLU) on the text converted from the audio signal (hereinafter referred to as “speech recognition result”), thereby recognizing or recommending one or more emojis for input by the user.

In some embodiments, a mapping relationship between emojis and corresponding descriptions may be stored locally in the memory 1209 or is accessible from a server, and the processing unit 1203 may be configured to recognize emoji(s) with the description close to the speech recognition result.

Further, the processing unit 1203 may, for example, evaluate the semantic similarity between a description of an emoji and the speech recognition result by calculating a similarity score. If an emoji shows a corresponding similarity score higher than a preset threshold, the processing unit 1203 may recommend the emoji to the user by displaying it through the displaying unit 1205. The processing unit 1203 may further synthesize an audio piece asking whether or not to input the emoji, and trigger the audio broadcasting unit 1207 to play the synthesized audio piece to the user.

If a plurality of emojis have a similarity score higher than the preset threshold, the processing unit 1203 may select the emoji with the highest similarity score for input by the user; or the processing unit 1203 may recommend the plurality of emojis to the user for selection. In some embodiments, approximately the same time when the processing unit 1203 recommends and displays a plurality of emojis through the displaying unit 1205, the audio broadcasting unit 1207 may play an audio piece asking the user to select one emoji for input from the plurality of displayed emojis.

In some other embodiments, the speech recognition result does not comprise the word “emoji”, and the processing unit 1203 may predict a plurality of emojis for input by the user based on a machine learning algorithm. The processing unit 1203 may calculate a prediction score for each predicted emoji, and recommend one or more emojis having a prediction score higher than a pre-determined threshold to the user. Similarly, the processing unit 1203 may generate an audio piece asking the user whether to input a recommended emoji or asking the user to choose from a plurality of recommended emojis for input.

After receiving the user response in the form of an audio signal, the audio collecting unit 1201 may convert the user response into text and figure out the user intention based on semantic recognition. Further, the processing unit 1203 may execute a corresponding operation upon determination of the user intention, such as add an emoji, select and add an emoji from a plurality of emojis, or end the current audio input process.

Further, the audio displaying unit 1205 may include a display screen displaying a user interface, where the user interface may display emoji(s), message, or any other information for view by the user. The audio broadcasting unit 1207 may be configured to broadcast or play any audio data or music under instructions of the processing unit 1203. The audio broadcasting unit 1207 may, for example, include one or more loudspeakers arranged based on actual demand of the user. The memory 1209 may be configured to store data and computer-readable instructions.

Based on embodiments of the present disclosure, the aforementioned method, device, unit and/or module may be implemented by using a system having the computing capacity to execute software that comprises computer instructions. Such system may include a storage device for implementing various storage manners mentioned in the foregoing descriptions. The system having the computing capability may include a device capable of executing computer instructions, such as a general-purpose processor, a digital signal processor, a specialized processor, a reconfigurable processor, etc., and the present disclosure is not limited thereto. Execution of such instructions may allow the system to be configured to execute the aforementioned operations of the present disclosure. The above-described device and/or module may be realized in one electronic device, or may be implemented in different electronic devices. Such software may be stored in a computer readable storage medium. The computer storage medium may store one or more programs (software modules), the one or more programs may comprise instructions, and when the one or more processors in the electronic device execute the instructions, the instructions enable the electronic device to execute the disclosed method.

Such software may be stored in forms of volatile memory or non-volatile memory (e.g., storage device similar as ROM), no matter whether it is erasable or overridable, or may be stored in the form of memory (e.g., RAM, memory chip, device or integrated circuit), or may be stored in optical readable media or magnetic readable media (e.g., CD, DVD, magnetic disc, or magnetic tape, etc.). It should be noted that, the storage device and storage media are applicable to machine-readable storage device embodiments storing one or more programs, and the one or more programs comprise instructions. When such instructions are executed, embodiments of the present disclosure are realized. Further, the disclosed embodiments provide programs and machine-readable storage devices storing the programs, and the programs include codes configured to realize the device or method described in any of the disclosed claims. Further, such programs may be electrically delivered via any medium (e.g., communication signal carried by wired connection or wireless connection), and various embodiments may appropriately include such programs.

The method, device, unit and/or module according to the embodiments of the present disclosure may further use a field-programmable gate array (FPGA), programmable logic array (PLA), system on chip (SOC), system on the substrate, system on encapsulation, application-specific integrated circuit (ASIC), or may be implemented using hardware or firmware configured to integrate or encapsulate the circuit in any other appropriate manner, or may be implemented in an appropriate combination of the three implementation manners of software, hardware, and firmware. Such system may include a storage device to realize the aforementioned storage. When implemented in such manners, the applied software, hardware, and/or firmware may be programmed or designed to execute the corresponding method, step, and/or function according to the present disclosure. Those skilled in the relevant art may implement one or more, or a part or multiple parts of the systems and modules by using different implementation manners appropriately based on actual demands. Such implementation manners shall all fall within the protection scope of the present disclosure.

Though the present disclosure is illustrated and described with reference to specific exemplary embodiment of the present disclosure, those skilled in the relevant art should understand that, without departing from appended claims and the spirit and scope of the present disclosure defined equivalently, various changes may be made to the present disclosure in the manner and detail. Therefore, the scope of the present disclosure shall not be limited to the aforementioned embodiments, but shall not be only determined by the appended claims, but may be further defined by equivalents of the appended claims.

What is claimed is:

1. A method for audio-based emoji input, comprising:
converting an audio signal input by a user into text through an automatic speech recognition (ASR) module;
based on the text, recognizing one or more emojis satisfying an input intention of the user;
requesting a confirmation of input of a recognized emoji or selection of an emoji from a plurality of recognized emojis;
receiving a user response; and
based on the user response, executing a corresponding operation.

2. The method according to claim 1, wherein, based on the text, recognizing one or more emojis satisfying an input intention of the user further comprises:
based on the text and a mapping relationship between emojis and corresponding descriptions, calculating a similarity score for the one or more recognized emojis, respectively.

3. The method according to claim 2, wherein:
when an emoji shows a similarity score higher than a preset threshold, recommending the emoji to the user.

4. The method according to claim 3, wherein, requesting a confirmation of input of a recognized emoji or selection of an emoji from a plurality of recognized emojis further comprises:
generating and broadcasting an audio piece asking the user whether or not to input the recommended emoji.

5. The method according to claim 2, wherein:
when a plurality of emojis each shows a similarity score higher than a preset threshold, selecting and recommending an emoji with a highest similarity score to the user, or sorting and recommending the plurality of emojis to the user in a descending order of similarity score.

6. The method according to claim 5, wherein, requesting a confirmation of input of a recognized emoji or selection of an emoji from a plurality of recognized emojis further comprises:
when the emoji with the highest similarity score is recommended to the user, generating and broadcasting an audio piece asking the user whether or not to input the recommended emoji; and
when the plurality of emojis are recommended to the user, generating and broadcasting an audio piece asking the user to select one emoji from the plurality of emojis for input.

7. The method according to claim 2, wherein:
the mapping relationship between the emojis and the corresponding descriptions is stored locally or is accessible from a server.

8. The method according to claim 1, wherein, based on the user response, executing a corresponding operation comprises:
when the user response is in a form of audio signal, converting the user response into a response text through the ASR module;
performing semantic recognition on the response text; and
based on a result of semantic recognition, executing the corresponding operation.

9. The method according to claim 8, wherein, the corresponding operation comprises:
confirming input of the recognized emoji, selecting an emoji from the plurality of recognized emojis, or ending a current input process.

10. The method according to claim 1, wherein, based on the text, recognizing one or more emojis satisfying an input intention of the user comprises:
based on the text and a machine learning algorithm, predicting a plurality of emojis for input by the user.

11. The method according to claim 10, wherein:
for each of the plurality of predicted emojis, a prediction score is calculated, and one or more emojis with a corresponding prediction score higher than a pre-determined threshold is recommended to the user.

12. The method according to claim 11, wherein:
when a plurality of emojis show a prediction score higher than the pre-determined threshold, respectively, selecting and recommending an emoji with a highest prediction score to the user, or sorting and recommending the plurality of emojis to the user in a descending order of prediction score.

13. The method according to claim 12, wherein, requesting a confirmation of input of a recognized emoji or selection of an emoji from a plurality of recognized emojis comprises:
when the emoji with the highest prediction score is recommended to the user, generating and broadcasting an audio piece asking the user whether or not to input the recommended emoji; and
when the plurality of emojis are recommended to the user, generating and broadcasting an audio piece asking the user to select one emoji from the plurality of emojis for input.

14. A device for audio-based emoji input, comprising:
an audio collecting unit, configured to receive an audio signal sent by a user;
at least one processor coupled to the audio collecting unit, wherein the at least one processor is configured to, receive the audio signal sent by the user, perform automatic speech recognition (ASR) on the received audio signal to convert the audio signal into text, and based on the text, recognize one or more emojis satisfying an input intention of the user; and
an audio broadcasting unit, configured to request the user to confirm input of a recognized emoji or select an emoji from a plurality of recognized emojis,
wherein responsive to receiving a user response, the at least one processor is further configured to execute a corresponding operation.

15. The device according to claim 14, wherein the at least one processor is further configured to:
based on the text and a mapping relationship between emojis and corresponding descriptions, calculate a similarity score for the one or more recognized emojis, respectively; or
based on the text and a machine learning algorithm, predict a plurality of emojis and calculate a prediction score for each of the plurality of emojis.

16. The device according to claim 15, wherein:
when a plurality of emojis each shows a similarity score higher than a preset threshold, the at least one processor is further configured to select and recommend an emoji with a highest similarity score to the user, or sort and recommend the plurality of emojis to the user in a descending order of similarity score.

17. The device according to claim 15, wherein:
when a plurality of emojis show a prediction score higher than the pre-determined threshold, respectively, the at least one processor is further configured to select and recommend an emoji with a highest prediction score to the user, or sort and recommend the plurality of emojis to the user in a descending order of prediction score.

18. The device according to claim 14, wherein when the user response is in a form of audio signal, the at least one processor is further configured to:
perform ASR on the user response for conversion into a response text; and
perform semantic recognition on the response text to determine whether or not to add the recognized emoji or select an emoji for input from the plurality of recognized emojis.

19. The device according to claim 18, wherein the corresponding operation executed by the at least one processor comprises:
adding the recognized emoji, selecting an emoji from the plurality of recognized emojis, or ending a current input process.

20. The device according to claim 14, wherein the audio broadcasting unit is further configured to:
when one emoji is recommended to the user, generate and broadcast an audio piece asking the user whether or not to input the recommended emoji; and
when the plurality of emojis are recommended to the user, generate and broadcast an audio piece asking the user to select one emoji from the plurality of emojis for input.
